(19) United States
(12) Patent Application Publication
(10) Pub. No.: US 2026/0366899 A1
(43) Pub. Date: Nov. 19, 2026

(54) FLOWTUBE SENSOR FORMED NECK FOR MAGNETIC FLOWMETER

(71) Applicant: Micro Motion, Inc., Boulder, CO (US)

(72) Inventors: Ryan W ORTH, Eden Prairie, MN (US); Mark S EMERY, Minneapolis, MN (US); Keyong ZHOU, Nanjing (CN); Yong CHEN, Nanjing (CN)

(21) Appl. No.: 19/670,515

(22) Filed: May 7, 2026

Related U.S. Application Data
(60) Provisional application No. 63/804,858, filed on May 13, 2025.

(51) Int. Cl. G01F 15/18; G01F 1/58; G01F 15/00; G01F 15/063; G01F 15/14

(52) U.S. Cl. CPC G01F 15/18; G01F 1/588; G01F 15/006; G01F 15/063; G01F 15/14

(57) ABSTRACT

A magnetic flowmeter includes a sensor flowtube, a transmitter, and a formed neck. The formed neck is coupled to the sensor flowtube and mounted the transmitter. The formed neck is a unitary component having a transition from an arcuate portion to a cylindrical portion. A formed neck is also provided.

### CROSS-REFERENCE TO RELATED APPLICATIONS

The present application is based on and claims the benefit of U.S. Provisional Patent Application Serial No. 63/804,858 filed May 13, 2025, the content of which application is hereby incorporated by reference in its entirety.

### BACKGROUND

Magnetic flowmeters (or magmeters) measure flow by application of Faraday’s Law, an electromagnetic effect. The magnetic flowmeter energizes one or more coils by passing an excitation current through field windings which generate a magnetic field across an electrically isolated, conductive process fluid flow. An electromotive force (EMF) is generated by the flowing process fluid crossing through the magnetic field. This induced voltage (potential) both across the fluid and with respect to the rest of the process fluid can readily be measured by one or more conductive electrodes that contact the flowing process fluid. The volumetric flow is proportional to the flow velocity and the cross-sectional area of the flowtube. The flow velocity is directly proportional to the electrode voltage potential (EV), which is directly proportional to the induced magnetic field strength (B). The induced magnetic field strength is assumed to be proportional to the applied magnetic field (H), which is directly linked to the magnitude of the excitation current. Thus, a direct correlation is provided between the measured electrode voltage potential and indicated volumetric flow.

Magnetic flowmeters are useful in a variety of conductive and semi-conductive fluid flow measurement environments. In particular, the flow of water-based fluids, ionic solutions and other conducting fluids can all be measured using magnetic flowmeters. Further, magnetic flowmeters are often used with fluids that may contain solids, such as pulp used in paper processing. Thus, magnetic flowmeters can be found in water treatment facilities, beverage and hygienic food production, chemical processing, high purity pharmaceutical manufacturing, as well as hazardous and corrosive fluid processing facilities. However, some environments are more susceptible to signal noise. Providing a magnetic flowmeter with a better response to signal noise would improve the accuracy of the flow output when used in such noisy environments.

Existing techniques in the industry for mounting the electronics housing to the flowtube sensor have limited appeal both in structural capability, mounting orientations, and in complexity (bulky, weight).

### SUMMARY

A magnetic flowmeter includes a sensor flowtube, a transmitter, and a formed neck. The formed neck is coupled to the sensor flowtube and mounted the transmitter. The formed neck is a unitary component having a transition from an arcuate portion to a cylindrical portion.

### BRIEF DESCRIPTION OF THE DRAWINGS

FIG. 1 is a diagrammatic view of an environment in which magnetic flowmeters in accordance with embodiments of the present invention are useful.

FIG. 2 is a block diagram of a magnetic flowmeter with which embodiments described herein are particularly useful.

FIG. 3 is a diagrammatic view of a magnetic flowmeter in accordance with an embodiment of the present invention.

FIG. 4 is a diagrammatic view of a formed neck coupling a sensor flowtube to a transmitter of a magnetic flowmeter in accordance with an embodiment of the present invention.

FIG. 5 is an image of a magnetic flowmeter having a formed neck in accordance with an embodiment of the present invention.

FIG. 6 is a diagrammatic view of a number of different line size magnetic flowmeters employing formed neck transmitter mounts in accordance with embodiments of the present invention.

### DETAILED DESCRIPTION OF ILLUSTRATIVE EMBODIMENTS

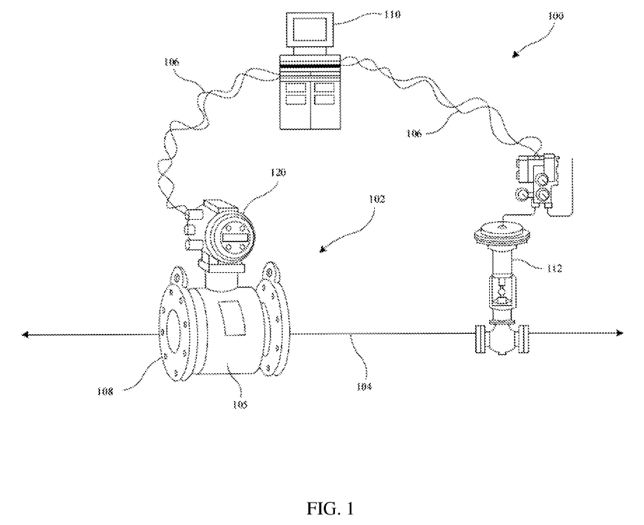

FIG. 1 illustrates a typical environment 100 for magnetic flowmeter 102. Magnetic flowmeter 102 is coupled to process piping, illustrated diagrammatically at line 104 that also couples to control valve 112. Magnetic flowmeter 102 is configured to provide a flow rate output relative to process fluid flow through piping 104 in a process. Examples of such fluids include slurries and liquids in chemical, pulp, pharmaceutical and other fluid processing plants.

Magnetic flowmeter 102 includes electronics housing or transmitter 120 connected to flowtube 108. Magnetic flowmeter 102 outputs are configured for transmission over relatively long distances to a controller or indicator via process communication connection 106. In typical processing plants, communication connection 106 can employ a digital communication protocol, an analog communication signal, or a combination thereof. The same or additional process information can be made available via wireless communication, pulse width or frequency output, or discrete input/outputs (DI/DO). System controller 110 can display flow information for a human operator as well as provide control signals over process communication connection 106 in order to control the process using control valves, such as valve 112.

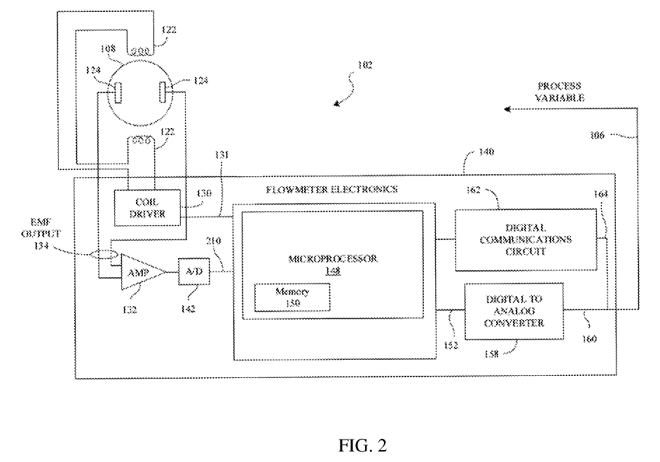

FIG. 2 is a block diagram of magnetic flowmeter 102 with which embodiments of the present invention are particularly applicable. Magnetic flowmeter 102 measures a flow of conductive process fluid through flowtube 108. Coils 122 are configured to apply an external magnetic field in the fluid flow in response to an applied excitation current from coil driver 130. EMF sensors (electrodes) 124 electrically couple to the fluid flow and provide an EMF signal output 134 to amplifier 132 related to an EMF generated in the fluid flow due to the applied magnetic field and fluid velocity. Analog-to-digital converter 142 provides a digitized EMF signal to microprocessor 148 of flowmeter electronics 140. The flowmeter electronics are typically located in the transmitter portion of the flowmeter.

Microprocessor 148 may be configured, through hardware, software, or a combination thereof, to provide digital signal processing functions relative to EMF output 134 in order to provide an output 152 related to fluid velocity. Microprocessor 148 may include or be coupled to memory 150 that contains instructions that, when executed by microprocessor 148, provide process fluid flow velocity output calculation. Microprocessor 148 calculates fluid flow velocity through flowtube 108 in accordance with a relationship between the EMF output 134 and flow velocity as described in an application of Faraday’s Law:
V=E/kBD

Where E can be the signal output 152 which is related to the EMF output 134, V is the velocity of the fluid, D is the diameter of flowtube 108, B is the strength of the induced magnetic field in the process fluid, and k is a constant of proportionality. Microprocessor 148 uses velocity and the measured magnetic field or coil current to calculate flow of the process fluid in accordance with known techniques. A digital-to-analog converter 158 is coupled to microprocessor 148 of flowmeter electronics 140 and generates an analog transmitter output 160 for coupling to communication bus 106. A digital communication circuit 162 may generate a digital transmitter output 164. The analog output 160 and/or digital output 164 can be coupled to process controllers or monitors, as desired.

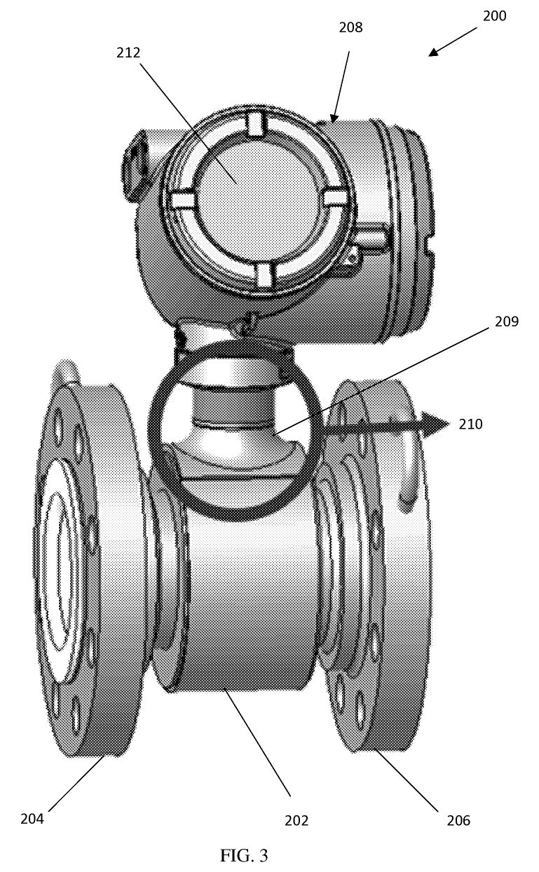

FIG. 3 is a diagrammatic perspective view of a magnetic flowmeter in accordance with an embodiment of the present invention. Magnetic flowmeter 200 includes a flowtube sensor 202 fluidically coupled between a pair of process fluid conduit flanges 204, 206. Transmitter 208 is mounted to sensor flowtube 202 by formed neck 209. Transmitter 208 includes flowmeter electronics 140 (shown in FIG. 2). As can be seen, transmitter 208 may include an operator interface 212. Additionally, since transmitter 208 may be required to operate in potentially hazardous environments, transmitter 208 may be required to comply with one or more explosion-proof requirements. One example of an explosion-proof rating is an ATEX certification to Ex-d standards EN60079-0 and ΕΝ60079-1 for potentially explosive atmospheres. Generally, explosion-proof housings are relatively bulky in order to be mechanically robust enough to contain an internal explosion without rupturing. As can be appreciated, a robust, bulky housing mounted to flowtube sensor 202 can undergo significant stresses at the interface between flowtube sensor 202 and transmitter 208 during any mechanical vibrations and/or impacts.

In accordance with an embodiment of the present invention, a single, drawn neck piece 209 robustly mounts transmitter 208 above flowtube sensor 202. This is different than how transmitters are typically mounted to welded flowtubes. In one example, flowtube sensor/magnetic enclosure 202 and formed neck 209 are formed of the same material. In one particular example, the material is stainless steel.

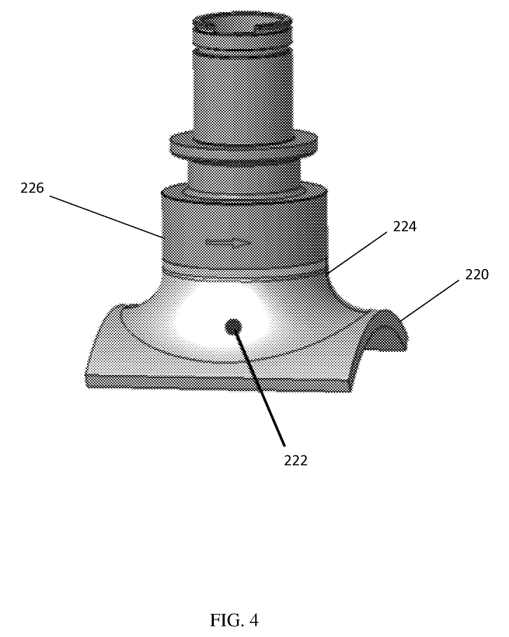

FIG. 4 is an enlarged diagrammatic view of region 210 of FIG. 3 showing a formed neck for coupling a sensor flowtube 202 to a transmitter 208 of a magnetic flowmeter 200 in accordance with an embodiment of the present invention. As can be seen, the formed neck includes an arcuate portion 220 that is generally configured to couple to the cylindrical surface of a flowtube sensor, such as flowtube sensor 202 (shown in FIG. 3). Arcuate portion 220 is the portion that is generally welded to flowtube sensor. Arcuate portion 220 includes a central transition portion 222 that transitions from arcuate portion 220 to a cylindrical portion 224 extending preferably perpendicularly from flowtube sensor 202. Cylindrical portion 224 includes or is coupled to union 226, which is configured to mount an electronics housing of transmitter 208. Such mounting may take any suitable form. Preferably, formed/drawn neck 209 (shown in FIG. 3) is manufactured as a single piece for added strength and simplicity. As used herein, the single piece neck 209 may be formed using casting, forging, stamping, drawing, forming, metal-injection-molding, additive manufacturing, or any other suitable manufacturing technique that results in a single unitary piece. The use of a single, unitary piece provides additional strength as no boundaries exist between portions of the unitary piece that could form cracks over time with exposure to repetitive mechanical motion or vibration.

Embodiments described herein provide improved vibration performance in comparison to current techniques in the magnetic flowmeter industry. The features of drawn neck piece 209 are preferably employed across a variety of line sizes (i.e., flowtube sensors of varying diameter) for magnetic flowmeters. As can be seen, formed neck 209 includes a gradual, rounded profile that provides smooth transition from magnetic enclosure (flowtube sensor) up to transmitter interface/cylindrical portion 224. The neck area which transitions sensor to transmitter mounting area is preferably constant across line sizes to provide a common appearance but grows near the base to accommodate different varieties of magnetics enclosures.

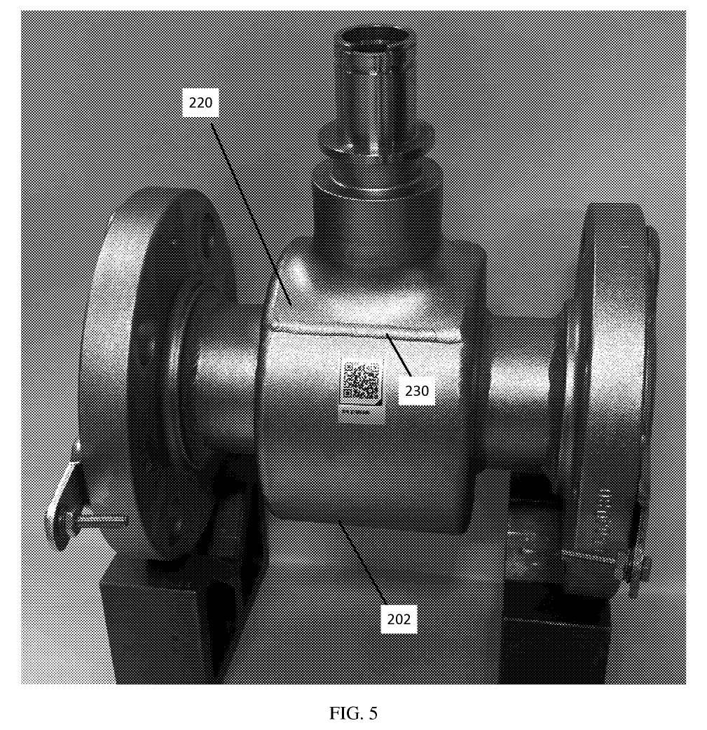

FIG. 5 is an image of a magnetic flowmeter having a formed neck in accordance with an embodiment of the present invention. As shown in FIG. 5, arcuate portion 220 is welded about its periphery to sensor flowtube 202 at weld 230. In the illustrated example, formed neck 209 and sensor flowtube are formed of the same material, such as stainless steel. However, other materials can be used. Further, different materials can be used for the formed neck 209 and sensor flowtube 202 as long as they are able to be welded together reliably.

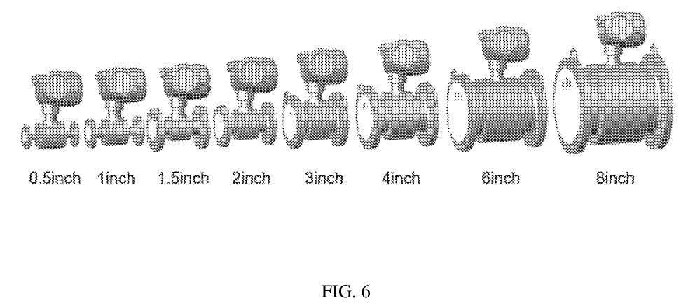

FIG. 6 is a diagrammatic view of a number of different line size magnetic flowmeters employing formed neck transmitter mounts in accordance with embodiments of the present invention. As can be seen, embodiments described herein are useful for a variety of line sizes. In the illustrated example, line sizes ranging from 0.5-inch diameter to 8-inch diameter are shown. For each line size, a specific formed neck 209 is used having an arcuate portion 220 (shown in FIG. 4) that has a curvature that matches the curvature of the particular sensor flowtube.

Although the present invention has been described with reference to preferred embodiments, workers skilled in the art will recognize that changes may be made in form and detail without departing from the spirit and scope of the invention. For example, while embodiments have been described with respect to a gradual transition in formed neck 209, alternatives can be employed, such as designs having the appearance of flanges, tubing, and/or a square design. Further, one or more reinforcing ribs or gussets may be used to couple the arcuate portion to the cylindrical portion as long as the formed neck remains a single, unitary piece.

What is claimed is:

1. A magnetic flowmeter comprising:
a sensor flowtube;
a transmitter; and
a formed neck coupled to the sensor flowtube and mounting the transmitter, the formed neck being a unitary component having a transition from an arcuate portion to a cylindrical portion.

2. The magnetic flowmeter of claim 1, wherein the formed neck is welded to the sensor flowtube.

3. The magnetic flowmeter of claim 2, wherein the arcuate portion of the formed neck is welded to the sensor flowtube.

4. The magnetic flowmeter of claim 1, wherein the arcuate portion of the formed neck has a curvature that matches a curvature of the sensor flowtube.

5. The magnetic flowmeter of claim 4, wherein the flowtube sensor has a line size ranging from 0.5-inch diameter to 8.0-inch diameter.

6. The magnetic flowmeter of claim 1, wherein the formed neck is constructed from stainless steel.

7. The magnetic flowmeter of claim 1, wherein the transmitter includes transmitter electronics configured to generate a magnetic field within the sensor flowtube, to detect an electromotive force (emf) in the process fluid, and to calculate a process fluid flow output based on the detected emf.

8. The magnetic flowmeter of claim 7, wherein the transmitter is configured to transmit the process fluid flow output to a remote device.

9. The magnetic flowmeter of claim 8, wherein the transmitter includes an explosion-proof housing.

10. The magnetic flowmeter of claim 1, wherein the formed neck includes a gradual transition from the arcuate portion to the cylindrical portion.

11. A formed neck for use in a magnetic flowmeter, the formed neck comprising:
an arcuate portion;
a cylindrical portion configured to mount a transmitter of the magnetic flowmeter; and
wherein the arcuate portion and the cylindrical portion are a single unitary piece.

12. The formed neck of claim 11, wherein the formed neck is constructed from stainless steel.

13. The formed neck of claim 11, wherein the formed neck is constructed by at least one of casting, forging, stamping, drawing, forming, metal-injection-molding, and additive manufacturing.

14. The formed neck of claim 11, wherein the arcuate portion has a curvature that matches a curvature of a particular line size sensor flowtube to which it is configured to mount.

15. The formed neck of claim 11, wherein the arcuate portion is formed of a metal that is weldable to a particular sensor flowtube to which it is configured to mount.

16. The formed neck of claim 11, wherein the arcuate portion is coupled to the cylindrical portion through a transition.

17. The formed neck of claim 16, wherein the transition is a gradual transition.

18. The formed neck of claim 11, and further comprising at least one reinforcing member
coupling the arcuate portion to the cylindrical portion.
